(19) United States
(12) Patent Application Publication
(10) Pub. No.: US 2025/0106341 A1
(43) Pub. Date: Mar. 27, 2025

(54) INFORMATION PROCESSING APPARATUS, PRINTING SYSTEM, STORAGE MEDIUM, AND METHOD OF CONTROLLING INFORMATION PROCESSING APPARATUS

(71) Applicant: CANON KABUSHIKI KAISHA, Tokyo (JP)

(72) Inventor: Hiroshi Kikuchi, Kanagawa (JP)

(21) Appl. No.: 18/887,226

(22) Filed: Sep. 17, 2024

(30) Foreign Application Priority Data
Sep. 21, 2023 (JP) 2023-155924

(51) Int. Cl. H04N 1/387; H04N 1/00

(52) U.S. Cl. CPC H04N 1/3875; H04N 1/00639; H04N 1/00925

(57) ABSTRACT

An information processing apparatus that is capable of communicating with a printing apparatus including a printing section that prints an image on a sheet and a plurality of sheet feeders that hold the sheets. A size of the sheet used for the printing is displayed on a basic settings sheet. A desired sheet feeder can be selected from the sheet feeders on a pamphlet preparation wizard. In a case where the desired sheet feeder is selected on the pamphlet preparation wizard, a size of sheets accommodated in the desired sheet feeder is reflected on the size of the sheet, which is displayed on the basic settings sheet.

### BACKGROUND OF THE INVENTION

### Field of the Invention

The present invention relates to an information processing apparatus, a printing system, a storage medium, and a method of controlling the information processing apparatus.

### Description of the Related Art

An information processing apparatus, such as a personal computer, can provide, in a state communicably connected to a printing apparatus, a print instruction to the connected printing apparatus. When providing a print instruction, a printer driver stored in the information processing apparatus in advance is used. The printer driver operates when data generated by a variety of applications, such as an application (software) for editing a document, is printed. Further, a user can configure print settings for setting print conditions by operating a user interface provided by the printer driver. The print settings include a setting of a size of a print sheet, selection of a sheet feeder from which a print sheet is fed, and so forth. Japanese Laid-Open Patent Publication (Kokai) No. 2010-67106 discloses a printing system including a computer and a plurality of printing apparatuses each communicably connected to the computer. In the printing system described in Japanese Laid-Open Patent Publication (Kokai) No. 2010-67106, the computer can select one of the plurality of printing apparatuses and cause the selected printing apparatus to perform printing. In this case, the printer driver performs control to prevent sizes of print sheets which cannot be used by the selected printing apparatus from being set on the print setting.

In general, the size of the print sheet is managed by an application. For example, in a case where printing is performed on a print sheet of the A3 size, the application instructs the printer driver to perform printing on the print sheet of the A3 size. Further, the user can designate a sheet feeder. Here, in a case where the user provides a print instruction for performing printing on a print sheet of the A3 size using the print settings, if not the print sheets of the A3 size, but print sheets of the A4 size are accommodated in the sheet feeder, an error is notified from the printing apparatus. This is because the priority is set to the sheet size specified by the application as the print sheet used for printing. Further, in the printing system described in Japanese Laid-Open Patent Publication (Kokai) No. 2010-67106, instead of providing the error notification, it is possible to perform printing on a print sheet of the A4 size by reducing the data size.

However, in a case where the user does not know that the sheet size specified by the application is the A3 size, if the error is notified when the user only selects the sheet feeder accommodating the print sheets of the A4 size, this is not user-friendly to the user. Thus, the printing apparatus can be degraded in the user-friendliness.

### SUMMARY OF THE INVENTION

The present invention provides a mechanism that makes it possible to reflect, when a sheet feeder (sheet holding unit) is selected, a size of print sheets corresponding to the selected sheet feeder on a size of a print sheet used for printing.

In a first aspect of the present invention, there is provided an information processing apparatus that is capable of communicating with a printing apparatus including a printing section that prints an image on a sheet and a plurality of sheet holding units that hold the sheets, including a first display unit configured to display a size of the sheet used for the printing, a second display unit configured to enable selection of a desired sheet holding unit from the plurality of sheet holding units, and a reflection unit configured to reflect, in a case where the desired sheet holding unit is selected on the second display unit, a size of sheets accommodated in the desired sheet holding unit on the size of the sheet, the size being displayed on the first display unit.

In a second aspect of the present invention, there is provided a printing system that includes a printing apparatus including a printing section that prints an image on a sheet and a plurality of sheet holding units that hold the sheets, and an information processing apparatus that is capable of communicating with the printing apparatus, wherein the information processing apparatus includes a first display unit configured to display a size of the sheet used for the printing, a second display unit configured to enable selection of a desired sheet holding unit from the plurality of sheet holding units, and a reflection unit configured to reflect, in a case where the desired sheet holding unit is selected on the second display unit, a size of sheets accommodated in the desired sheet holding unit on the size of the sheet, which is displayed on the first display unit.

According to the present invention, it is possible to reflect, when a sheet feeder (sheet holding unit) is selected, a size of print sheets corresponding to the selected sheet feeder (sheet holding unit) on a size of a print sheet used for printing.

Further features of the present invention will become apparent from the following description of exemplary embodiments (with reference to the attached drawings).

### BRIEF DESCRIPTION OF THE DRAWINGS

FIG. 1 is a block diagram showing an example of a configuration of a printing system.

FIG. 2 is a block diagram showing an example of a hardware configuration of a computer.

FIG. 3 is a block diagram showing an example of a hardware configuration of a printer.

FIG. 4 is a block diagram showing an example of a software configuration of the computer.

FIG. 5 is a diagram useful for explaining processing operations performed between the software items shown in FIG. 4.

FIG. 6A is a diagram showing an example of a print settings dialog displayed by a UI processor.

FIG. 6B is a diagram showing an example of the print settings dialog displayed by the UI processor.

FIG. 7 is a diagram showing a bookbinding details dialog displayed by the UI processor.

FIG. 8 is a diagram showing a simple wizard sheet included in the print settings dialog shown in FIG. 6A.

FIG. 9 is a diagram showing a first screen of a pamphlet preparation wizard included in the simple wizard sheet shown in FIG. 8.

FIG. 10 is a diagram showing a second screen of the pamphlet preparation wizard included in the simple wizard sheet shown in FIG. 8.

FIG. 11 is a diagram showing a third screen of the pamphlet preparation wizard included in the simple wizard sheet shown in FIG. 8.

FIG. 12 is a flowchart of a display process on the pamphlet preparation wizard.

FIG. 13 is a diagram showing a table associated with changes of print settings generated on the pamphlet preparation wizard.

FIG. 14 is a flowchart of a process for generating the print settings in a column 1303 in FIG. 13.

FIG. 15 is a flowchart of a process for generating the print settings in a column 1304 in FIG. 13.

FIG. 16 is a flowchart of a process for generating the print settings in a column 1305 in FIG. 13.

FIG. 17 is a flowchart of a process for generating the print settings in a column 1306 in FIG. 13.

FIG. 18 is a flowchart of a process performed by a drawing processor of a printer driver, for determining an enlargement/reduction ratio to be set when printing is performed.

### DESCRIPTION OF THE EMBODIMENTS

The present invention will now be described in detail below with reference to the accompanying drawings showing embodiments thereof. However, the components described in the following embodiments are described only by way of example, and are by no means intended to limit the scope of the present invention to them alone. For example, each of the components forming the present invention can be replaced by a desired component which can exhibit the same function. Further, desired components can be added. Furter, two or more desired configurations (features) of the embodiments can be combined.

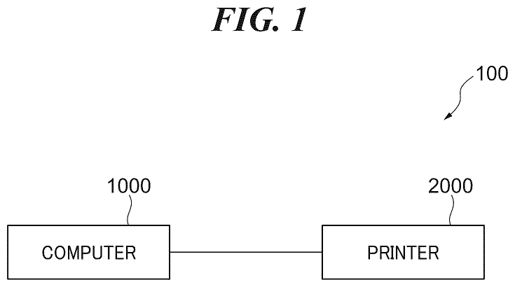

FIG. 1 is a block diagram showing an example of a configuration of a printing system. The printing system shown in FIG. 1, denoted by reference numeral 100, includes a computer (information processing apparatus) 1000 and a printer (printing apparatus) 2000, and these are communicably connected to each other. Further, the computer 1000 and the printer 2000 are also communicably connected e.g. to a universal serial bus (USB) device or a network.

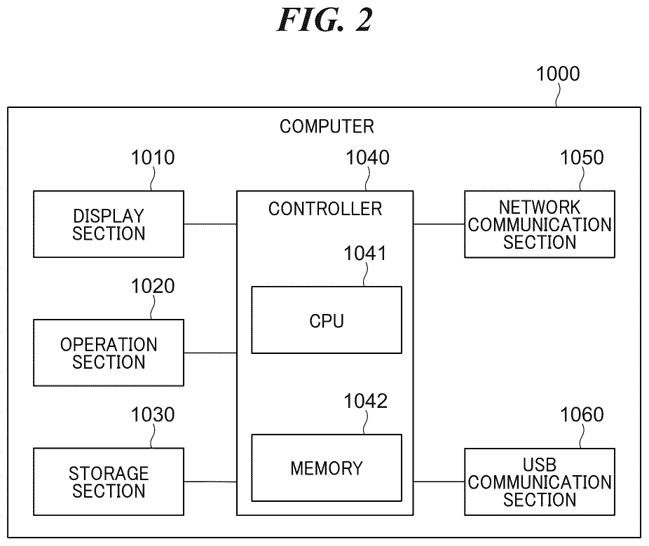

FIG. 2 is a block diagram showing an example of a hardware configuration of the computer. The computer 1000 shown in FIG. 2 is e.g. a desktop-type or laptop-type personal computer, a tablet terminal, or a smartphone. This computer 1000 includes a display section 1010, an operation section 1020, a storage section 1030, a controller 1040, a network communication section 1050, and a USB communication section 1060. The controller 1040 includes a central processing unit (CPU) 1041 and a memory 1042. The display section 1010 is an output device, such as a display having a liquid crystal panel. The operation section 1020 is an input device, such as a mouse, a keyboard, and a touch panel. The storage section 1030 is a storage medium, such as a hard disk or a solid state drive (SSD), and stores a variety of software necessary for the operation of the computer 1000. The software is not particularly limited, but includes, for example, a program for causing the controller 1040 to execute a method of controlling the components and means of the computer 1000 (method of controlling the information processing apparatus). Further, a printer driver 1200, described hereinafter, is also stored in the storage section 1030. The software is loaded into the memory 1042 as required and is executed by the CPU 1041. The software processing operations in the present embodiment are all realized by the CPU 1041 that executes the software stored in the storage section 1030 and loaded into the memory 1042 of the controller 1040. The network communication section 1050 is connected to a network to input and output data from and to an external apparatus. The USB communication section 1060 inputs and outputs data from and to an external apparatus by USB connection.

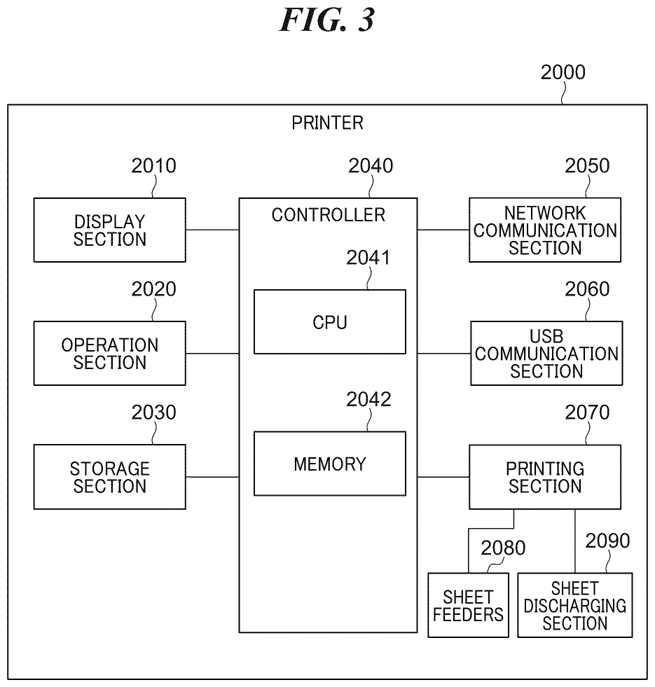

FIG. 3 is a block diagram showing an example of a hardware configuration of the printer. The printer 2000 shown in FIG. 3 is a multi-function peripheral (MFP) having e.g. a print function, a copy function, a scan function, and a facsimile function but can be an apparatus having at least the print function. Note that in the present embodiment, the printer 2000 is configured to be capable of performing bookbinding printing. This printer 2000 includes a display section 2010, an operation section 2020, a storage section 2030, a controller (control unit) 2040, a network communication section 2050, a USB communication section 2060, a printing section 2070, a plurality of sheet feeders 2080, and a sheet discharging section 2090. The controller 2040 includes a CPU 2041 and a memory 2042. The display section 2010 is an output device, such as a display having a liquid crystal panel. The operation section 2020 is an input device, such as a touch panel. The storage section 2030 is a storage medium, such as a hard disk or an SSD, and stores a variety of software necessary for the operation of the printer 2000. The software is loaded into the memory 2042 as required and is executed by the CPU 2041. The network communication section 2050 is connected to a network to input and output data from and to an external apparatus. The USB communication section 2060 inputs and outputs data from and to an external apparatus as required.

The printing section 2070 prints digital data stored in the storage section 2030 or the memory 2042 on a print sheet (hereinafter sometimes simply referred to as the “sheet”) according to an instruction from the controller 2040. The printing method is not particularly limited, but for example, an inkjet method, a toner method, or any other method can be used. In the present embodiment, the printer 2000 has the sheet feeders 2080. In the respective sheet feeders 2080, print sheets of respective sizes are accommodated. A print sheet is fed from each sheet feeder 2080 to the printing section 2070. Further, the sheet feeders 2080 include ones storing print sheets which are equal in size to each other but are different in type from each other. The sheet discharging section 2090 performs finish processing on print sheets subjected to printing. The finish processing is not particularly limited, but for example, stapling, punching, folding, saddle-stitching, or the like is performed. In the printer 2000, printing is performed on a print sheet fed from the sheet feeder 2080 according to a print request received from the computer 1000. Then, the print sheet on which printing has been performed is subjected to the finish processing in the sheet discharging section 2090.

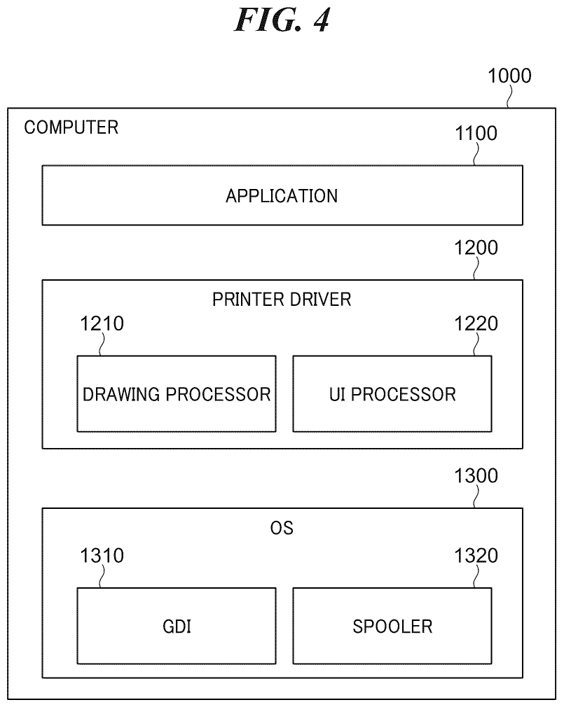

FIG. 4 is a block diagram showing an example of a software configuration of the computer. As shown in FIG. 4, the computer 1000 includes an application 1100, the printer driver 1200, and an operating system (OS) 1600. The printer driver 1200 has a drawing processor 1210 and a user interface (UI) processor 1220. The OS 1600 has a graphic device interface (GDI) 1310 and a spooler 1320. All of these software items included in the computer 1000 are stored in the storage section 1030. The application 1100 is arbitrary software, such as document generation software and spreadsheet software, and has the print function. By executing this print function, it is possible to print e.g. information displayed on the display section 1010 of the computer 1000 by using the printer 2000. The printer driver 1200 displays the print settings which can be realized by the printer 2000 on the display section 1010 and generates drawing data (page description language (PDL) data) which can be interpreted by the printer 2000. The UI processor 1220 is mainly used when the print settings are displayed and changed. The drawing processor 1210 is mainly used when PDL data is generated. The OS 1600 is software for controlling the operation of the computer 1000. The OS 1600 can also control the application 1100 and the printer driver 1200. Note that the application 1100 and the printer driver 1200 become available when installed. The GDI 1310 is a component that provides an interface related to operations of drawing, such as display and printing, to the outside. The spooler 1320 performs processing for transmitting print data to the printer 2000.

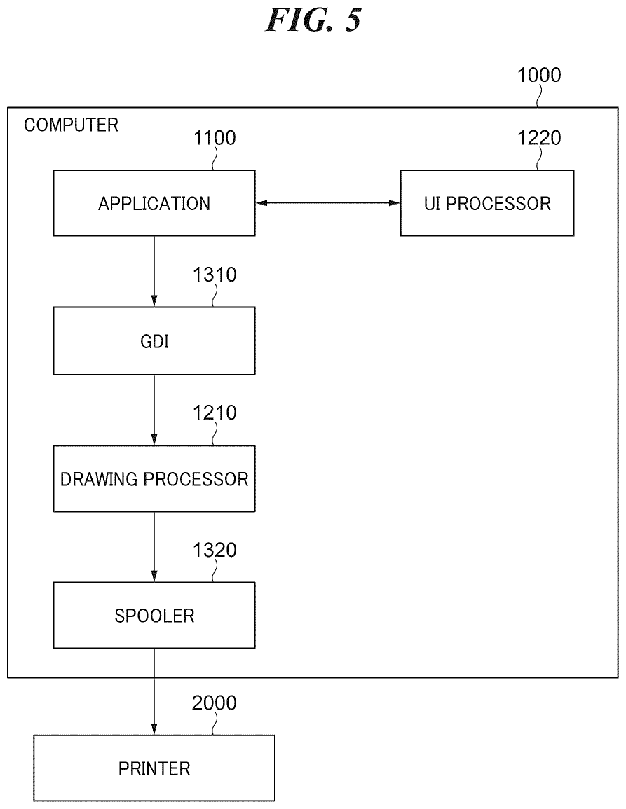

FIG. 5 is a diagram showing processing operations performed between the software items shown in FIG. 4. As shown in FIG. 5, the application 1100 calls the UI processor 1220 of the printer driver 1200 before executing print processing. With this, the user can make desired print settings on a UI displayed by the UI processor 1220. After making the print settings, the application 1100 calls a drawing command as the contents of printing related to the GDI 1310 with the print settings acquired via the UI processor 1220. The GDI 1310 converts the print settings and the drawing command to commands which can be interpreted by the printer driver 1200 and calls the drawing processor 1210. The drawing processor 1210 converts the print settings and the drawing command, acquired via the GDI 1310, to PDL data which can be interpreted by the printer 2000 and passes the PDL data to the spooler 1320. The spooler 1320 transmits the PDL data to the printer 2000. The printer 2000 converts the PDL data received from the spooler 1320 to image data and prints the image data in the printing section 2070.

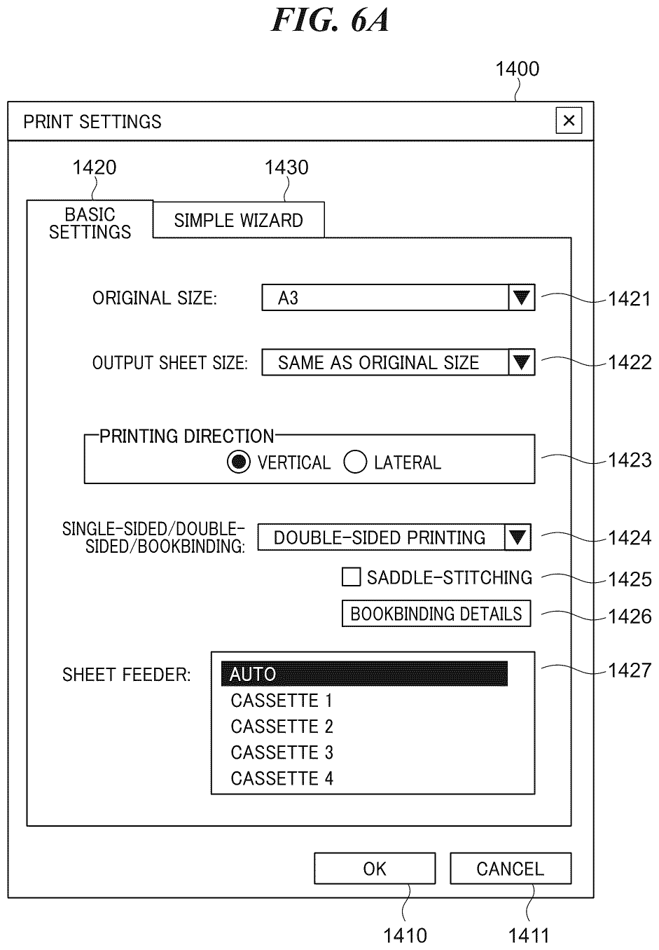

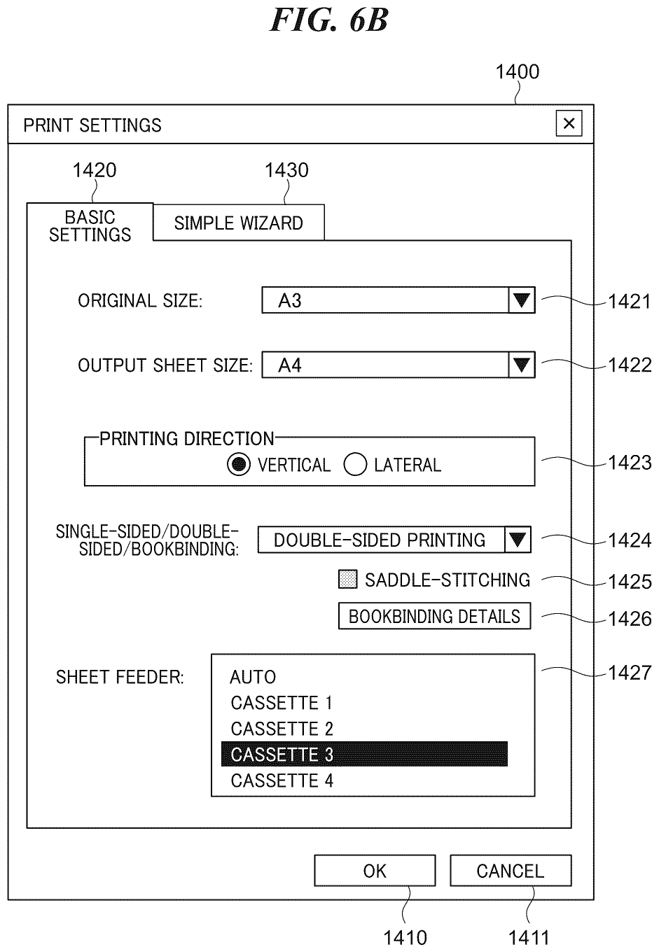

FIGS. 6A and 6B are diagrams each showing an example of a print settings dialog displayed by the UI processor. The user can make desired print settings by operating a print settings dialog 1400 shown in FIG. 6A on the operation section 1020. The print settings dialog 1400 includes a basic settings sheet 1420 and a simple wizard sheet 1430. The basic settings sheet 1420 is a sheet for making basic settings of the print settings. The basic settings sheet 1420 functions as a first display unit configured to display a size of a print sheet used for printing, and so forth. This basic settings sheet 1420 includes a document size field 1421, an output sheet size field 1422, a printing direction setting 1423, a single-sided/double-sided/bookbinding setting 1424, a saddle-stitching setting 1425, a bookbinding details button 1426, and a sheet feeder setting 1427. Further, the basic settings sheet 1420 includes an OK button 1410 and a cancel button 1411.

In the document size field 1421, a size of a print sheet, which is set by document data for printing (hereinafter referred to as the “document size”), is displayed. In the default state (initial state), this document size is specified by the application 1100 as the above-mentioned desired software, such as the document generation software and the spreadsheet software. For example, in a case where the size of document data generated by the application 1100 is the “A3” size, “A3” is displayed in the document size field 1421. In the output sheet size field 1422, a size of a print sheet to be actually used for printing (hereinafter referred to as the “output sheet size”) is displayed. This output sheet size is set to the same size as the document size in the default state. Note that in a case where the output sheet size is set to a size different from the document size by operating the output sheet size field 1422, printing is performed in a state in which the size is enlarged/reduced according to a ratio of the document size and the output sheet size. In the printing direction setting 1423, the user can select, when printing document data, whether to vertically or laterally print the data. The printing direction setting 1423 is specified by the application 1100 in the default state. In the single-sided/double-sided/bookbinding setting 1424, the user can select whether to perform single-sided printing only on a front surface of a print sheet, perform double-sided printing on both of a front surface and a reverse surface of a print sheet, or perform double-sided printing after setting imposition for bookbinding. The saddle-stitching setting 1425 and the bookbinding details button 1426 are enabled, i.e. can be operated in a case where bookbinding printing is performed. The saddle-stitching setting 1425 is a check box, and when this check box is checked, saddle-stitching is performed as the finish processing performed by the sheet discharging section 2090. The “saddle-stitching” refers to processing for collectively binding a plurality of print sheets with staples in a central part. The bookbinding details button 1426 will be described hereinafter.

As described above, the printer 2000 has the sheet feeders 2080 accommodating print sheets of respective sizes. In the sheet feeder setting 1427, the user can select a sheet feeder 2080 accommodating print sheets of a desired size from the sheet feeders 2080. In the sheet feeder setting 1427, “auto” is set in the default state. In this case, a sheet feeder 2080 accommodating print sheets of a size matching the output sheet size is selected. Note that in the configuration shown in FIG. 6A, the sheet feeder setting 1427 includes not only “auto”, but also “cassette 1”, “cassette 2”, “cassette 3”, and “cassette 4”, as the options. The options “cassette 1” to “cassette 4” each refer to the sheet feeder 2080. The information on “cassette 1” to “cassette 4” is acquired by the printer driver 1200. Here, any one of the options in the sheet feeder setting 1427 can be selected regardless of the print settings set e.g. in the document size field 1421 and the output sheet size field 1422. Further, the print settings made e.g. in the document size field 1421 and the output sheet size field 1422 are not changed whichever option in the sheet feeder setting 1427 is selected. When the OK button 1410 is operated, i.e. pressed, the print settings specified on the print settings dialog 1400 are saved, and the print settings dialog 1400 is closed. Further, when the cancel button 1411 is operated, the print settings specified on the print settings dialog 1400 are discarded, and the print settings dialog 1400 is closed. Note that the print settings which can be specified on the print settings dialog 1400 are not limited to those shown in FIG. 6A.

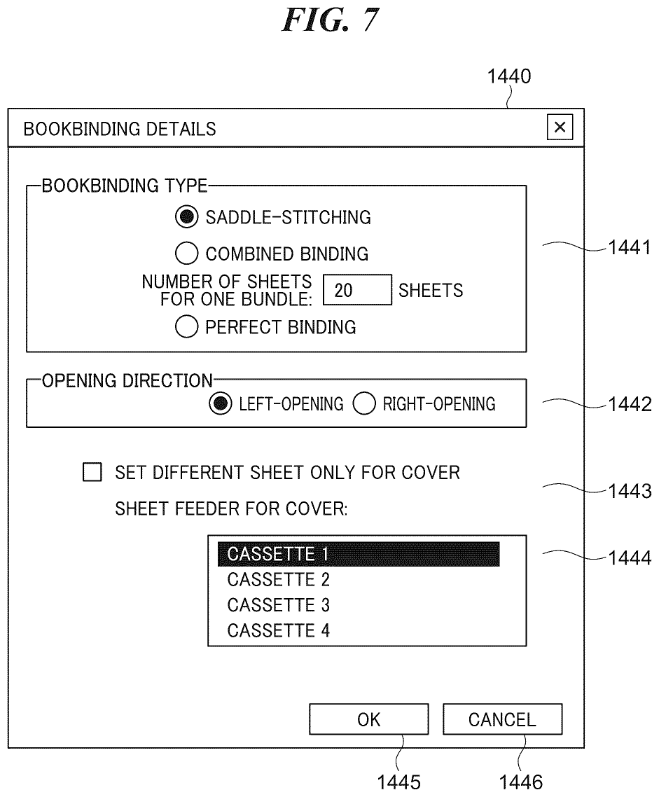

FIG. 7 is a diagram showing a bookbinding details dialog displayed by the UI processor. A bookbinding details dialog 1440 shown in FIG. 7 is displayed by operating the bookbinding details button 1426 on the print settings dialog 1400. The bookbinding detail dialog 1440 includes a bookbinding type setting 1441, an opening direction setting 1442, an only cover-different sheet setting 1443, a sheet feeder setting 1444, an OK button 1445, and a cancel button 1446. In the bookbinding type setting 1441, the user can select “saddle-stitching”, “combined binding”, and “perfect binding”. The “saddle-stitching” refers to a bookbinding method of collectively binding all pages by performing saddle-stitching. The “combined binding” is used e.g. in a case where the number of pages is relatively large and refers to a bookbinding method in which printed sheets are divided into bundles, each formed by a predetermined number of printed sheets and subjected to saddle-stitching, and a book is bound by stacking the bundles. Further, in the “combined binding”, the number of printed sheets per one bundle can be specified. The “perfect binding” refers to combined binding in a case where the number of print sheets per one bundle is one, and a book is bound by stacking all bundles. In the “perfect binding”, the above-mentioned stapling in a central part is not performed. Selection in the bookbinding type setting 1441 affects the order of bookbinding imposition which is performed when print data (document data) of each page sent from the application 1100 to the printer driver 1200 is imposed. For example, in a case where “saddle-stitching” is selected in the bookbinding type setting 1441, if print data has eight pages, the first page and the eighth page are imposed side by side on the same surface of the first sheet. Further, on the reverse surface of this sheet, the second page and the seventh page are imposed side by side. Similarly, the third page and the sixth page are imposed on the same surface of the second sheet, and the fourth page and the fifth page are imposed on the reverse surface of the second sheet. By stapling the central part of the two sheets printed as described above, one book is completed. Further, in a case where “combined binding” or “perfect binding” is selected in the bookbinding type setting 1441, imposition different from the case where “saddle-stitching” is selected is performed such that one book is completed by stacking a plurality of bundles.

In the opening direction setting 1442, the user can select whether to make a book to be obtained by bookbinding as a left-opening type or a right-opening type. Similar to the selection in the bookbinding type setting 1441, the selection in the opening direction setting 1442 also affects the order of bookbinding imposition. The only cover-different sheet setting 1443 is a check box, and when this check box is checked, it is possible to designate a different sheet only for the front cover. With this, it is possible to feed only the front cover, i.e. the outermost sheet of the book to be obtained by bookbinding, from a sheet feeder 2080 different from sheet feeders 2080 for feeding sheets other than the front cover. In the bookbinding, there is a case where it is preferable to use a rich sheet, such as coated paper and glossy paper, for the front cover. In the sheet feeder setting 1444, the user can select a sheet feeder 2080 for feeding a sheet for the front cover in a state in which the only cover-different sheet setting 1443 is checked. Note that in the configuration shown in FIG. 7, the sheet feeder setting 1444 includes “cassette 1”, “cassette 2”, “cassette 3”, and “cassette 4” as the options. The options “cassette 1” to “cassette 4” each refer to a sheet feeder 2080 for feeding a sheet for the front cover. When the OK button 1445 is operated, the bookbinding settings specified in the bookbinding details dialog 1440 are saved, and the bookbinding details dialog 1440 is closed. Further, when the cancel button 1446 is operated, the bookbinding settings specified in the bookbinding details dialog 1440 are discarded, and the bookbinding details dialog 1440 is closed. Note that the bookbinding settings which can be specified on the bookbinding details dialog 1440 are not limited to those shown in FIG. 7.

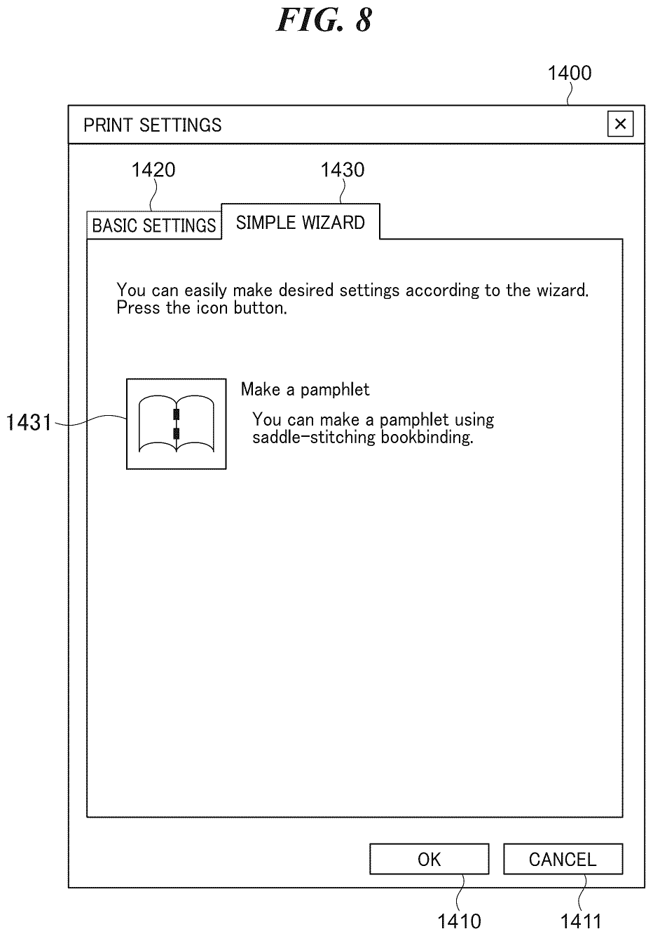

FIG. 8 is a diagram showing the simple wizard sheet included in the print settings dialog shown in FIG. 6A. The simple wizard sheet 1430 shown in FIG. 8 is an auxiliary screen used by the user to relatively simply perform the print setting for obtaining a desired printout (product). The simple wizard sheet 1430 includes a button 1431. The button 1431 is a button for making a pamphlet. Note that the pamphlet is made by a saddle-stitching function stored in the printer driver 1200 in advance. Further, in a case where saddle-stitching is not included in the finish processing performed by the sheet discharging section 2090, the button 1431 or the simple wizard sheet 1430 is not displayed. The simple wizard sheet 1430 is the auxiliary screen as mentioned above. Therefore, the setting items set on the simple wizard sheet 1430 sometimes overlap the setting items set on the basic settings sheet 1420 and the bookbinding details dialog 1440.

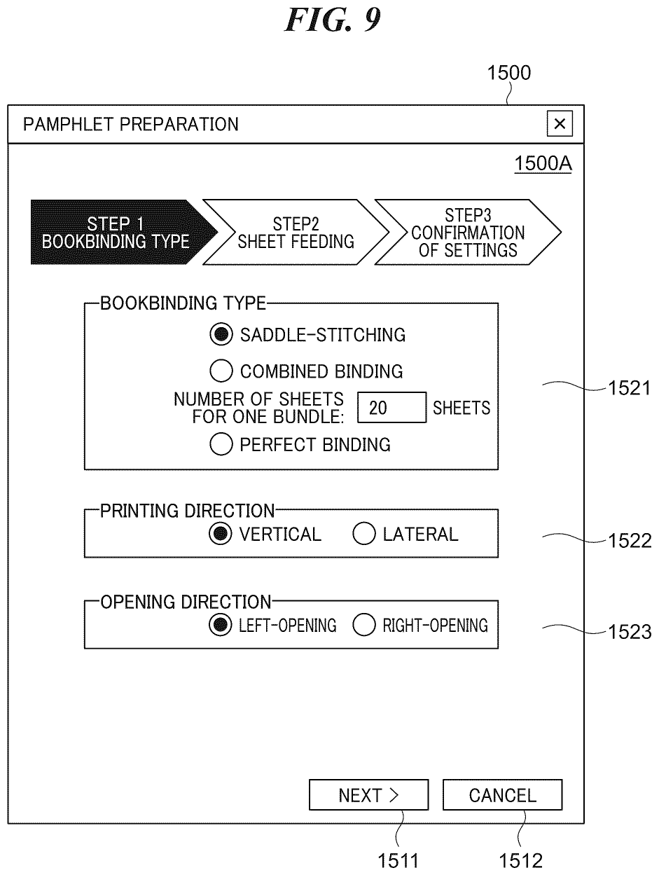

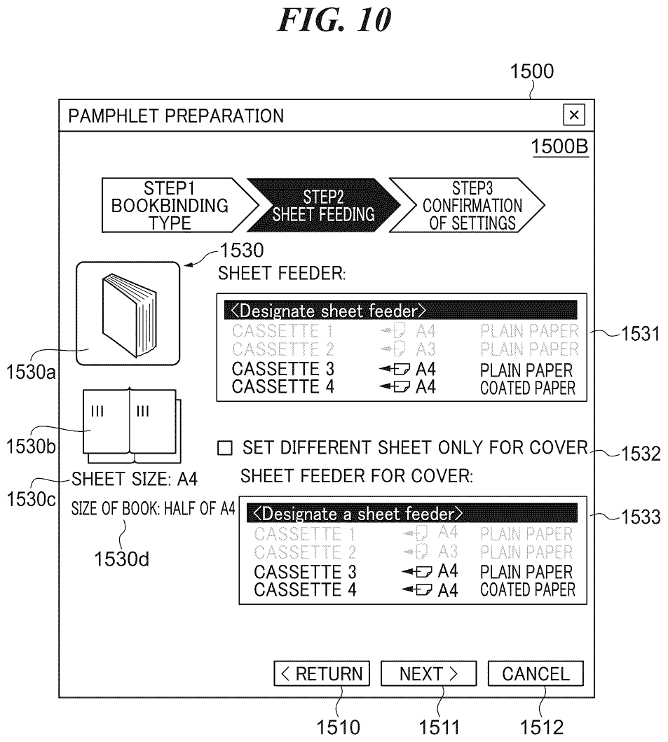

FIG. 9 is a diagram showing a first screen of a pamphlet preparation wizard included in the simple wizard sheet shown in FIG. 8. A pamphlet preparation wizard 1500 shown in FIG. 9 is displayed on a screen different from the basic settings sheet 1420. The pamphlet preparation wizard 1500 functions as a second display unit configured to display an operation screen which is enabled (becomes operable) in a case where bookbinding printing is performed. A first screen 1500A is included in the pamphlet preparation wizard 1500. The first screen 1500A is displayed by operating the button 1431 on the simple wizard sheet 1430. The first screen 1500A includes a bookbinding type setting 1521, a printing direction setting 1522, an opening direction setting 1523, a next button 1511, and a cancel button 1512. The bookbinding type setting 1521 is the same as the bookbinding type setting 1441 on the bookbinding details dialog 1440. The printing direction setting 1522 is the same as the printing direction setting 1423 on the basic settings sheet 1420. The opening direction setting 1523 is the same as the opening direction setting 1442 on the bookbinding details dialog 1440. When the next button 1511 is operated, the pamphlet preparation wizard 1500 is switched from the first screen 1500A to a second screen 1500B shown in FIG. 10. Further, when the cancel button 1512 is operated, the print settings specified on the pamphlet preparation wizard 1500 are all discarded, and the pamphlet preparation wizard 1500 is closed.

FIG. 10 is a diagram showing the second screen of the pamphlet preparation wizard included in the simple wizard sheet shown in FIG. 8. The second screen 1500B shown in FIG. 10 is included in the pamphlet preparation wizard 1500. The second screen 1500B is a screen for specifying items related to sheet feeding. The second screen 1500B includes a preview 1530, a sheet feeder setting 1531, an only cover-different sheet setting 1532, a sheet feeder setting 1533, a return button 1510, the next button 1511, and the cancel button 1512. In the sheet feeder setting 1531, information items associated with the sheet feeders 2080 are displayed, respectively. This information includes, for example, a name of each sheet feeder 2080, a direction (setting direction) of sheets accommodated in each sheet feeder 2080, a size of sheets accommodated in each sheet feeder 2080, and a type of sheets accommodated in each sheet feeder 2080. For example, in the configuration shown in FIG. 10, the information indicates that “plain paper” of the “A4” size is accommodated in the “cassette 1” in a “laterally set”state. Further, the information indicates that “plain paper” of the “A3” size is accommodated in the “cassette 2” in a “laterally set” state. Further, the information indicates that “plain paper” of the “A4” size is accommodated in the “cassette 3” in a “vertically set” state and “coated paper” of the “A4” size is accommodated in the “cassette 4” in a “vertically set” state. With this, the user can select a sheet feeder setting 1531 to be used, i.e. a desired sheet feeder setting 1531 while confirming a type of sheets accommodated in each sheet feeder 2080 and a direction in which the sheets are accommodated.

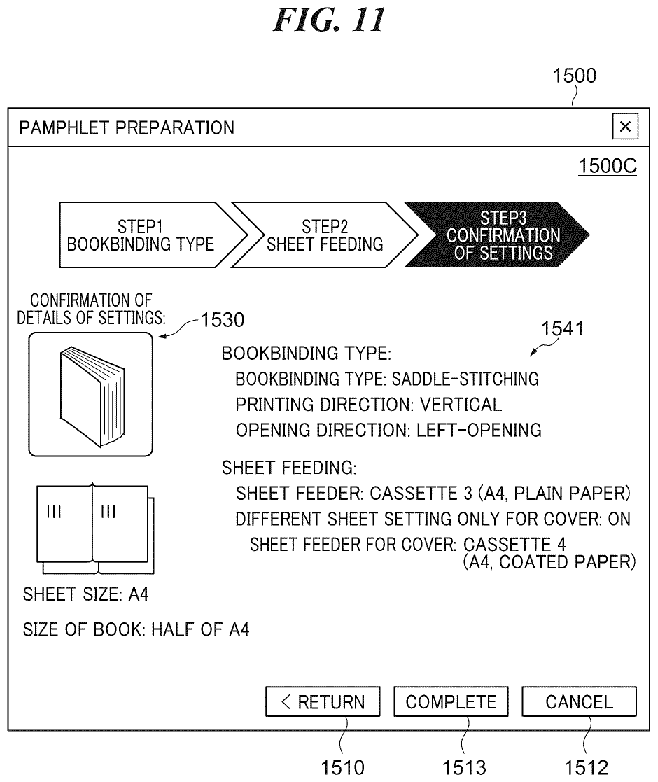

Further, in the sheet feeder setting 1531, the user can select a desired sheet feeder 2080 from the sheet feeders 2080. For example, in the configuration shown in FIG. 10, although “cassette 1” and “cassette 2” are grayed out and inhibited from being selected, “cassette 3” and “cassette 4” are in the selectable state. When the user selects a desired sheet feeder 2080 in the sheet feeder setting 1531, the second screen 1500B can be switched to a third screen 1500C shown in FIG. 11. Note that the second screen 1500B remains displayed until a desired sheet feeder 2080 is selected in the sheet feeder setting 1531. In the sheet feeder setting 1531, selection of the sheet size can be restricted depending on e.g. a type of bookbinding printing. Specifically, based on the capability of the sheet discharging section 2090, a sheet feeder 2080 accommodating sheets in a direction disabling saddle-stitching and a sheet feeder 2080 accommodating sheets of a size disabling saddle-stitching are inhibited from being selected. As mentioned above, “cassette 1” and “cassette 2” are grayed out. This is because “cassette 1” and “cassette 2” indicate the sheet feeders 2080 accommodating sheets in a direction disabling saddle-stitching. This makes it possible to prevent the sheet feeder 2080 which is not suitable for desired bookbinding from being selected. Note that the same inhibition can be applied to the combined binding and the perfect binding.

The only cover-different sheet setting 1532 is a check box, and when this check box is checked, selection in the sheet feeder setting 1533 is enabled. In the sheet feeder setting 1533, the user can select a desired sheet feeder 2080 accommodating a sheet which is desired to be printed as the front cover, from the sheet feeders 2080. Note that the configuration of the sheet feeder setting 1533 is the same as the configuration of the sheet feeder setting 1531 in the present embodiment but is not limited to this. Thus, on the second screen 1500B, it is possible to select a desired sheet size separately for the front cover and for the part after the front cover of the book (print product) to be acquired by bookbinding. With this, for example, it is possible to use coated paper for the front cover and plain paper for the part after the front cover.

In the preview 1530, a sample of a book to be acquired by bookbinding is displayed. This makes it possible to grasp a finished state of the book before executing bookbinding. As the sample of the book, in the configuration shown in FIG. 10, a perspective view 1530a of the book and a spread view 1530b showing a spread state of the book are displayed, by way of example. Note that the perspective view 1530a is changed according to e.g. a type of bookbinding and an opening direction of the book. The spread view 1530b is changed according to e.g. a type of bookbinding, an opening direction of the book, and a type of the display. Further, the spread view 1530b includes e.g. a view showing the front cover and the back cover in a spread state and a view showing pages on which body text is printed in a spread state. Further, the sample of the book also includes a sheet size 1530c, i.e. a size of sheets used for bookbinding, and a size 1530d of a book obtained by using sheets of this size and folding the central part of the sheets. This shows a relationship between the size of sheets used for bookbinding and the size of the book to be actually acquired, and makes it possible to grasp a size of the book, based on the sheets used for bookbinding. When the next button 1511 is operated, the pamphlet preparation wizard 1500 can be switched from the second screen 1500B to the third screen 1500C. Further, when the cancel button 1512 is operated, the print settings specified on the second screen 1500B are all discarded, and the pamphlet preparation wizard 1500 is closed. When the return button 1510 is operated, the pamphlet preparation wizard 1500 returns from the second screen 1500B to the first screen 1500A. Note that although the information on the sheet feeders 2080 of the printer 2000 can be acquired by the printer driver 1200, there is a possibility that it is difficult for the printer driver 1200 to acquire the information, depending e.g. on a communication state between the computer 1000 and the printer 2000. In this case, the sheet size in the sheet feeder setting 1531 is displayed as “unknown”, and the user can input the sheet size displayed as “unknown” on the operation section (input unit) 1020. With this, the printer driver 1200 can acquire the sheet size displayed as “unknown”.

FIG. 11 is a diagram showing the third screen of the pamphlet preparation wizard included in the simple wizard sheet shown in FIG. 8. The pamphlet preparation wizard 1500 includes the third screen 1500C shown in FIG. 11. The third screen 1500C is a screen for prompting a user to confirm the contents set on the first screen 1500A and the second screen 1500B. The third screen 1500C includes a setting contents confirmation area 1541, the return button 1510, a completion button 1513, and the cancel button 1512. In the setting contents confirmation area 1541, the setting contents specified on the first screen 1500A and the second screen 1500B are displayed. With this, the user can confirm the setting contents. Further, the setting contents confirmation area 1541 includes the preview 1530. When the completion button 1513 is operated, the setting contents specified on the first screen 1500A and the second screen 1500B are saved, and the pamphlet preparation wizard 1500 is closed.

Then, these setting contents are reflected on a variety of settings set on the basic settings sheet 1420 and the bookbinding details dialog 1440. This reflection will be described. As shown in FIG. 6A, on the basic settings sheet 1420, the output sheet size field 1422 is set to “same as document size”. Let it be assumed that “cassette 3” is selected in the sheet feeder setting 1531 on the second screen 1500B of the pamphlet preparation wizard 1500 from this state. In this case, the controller (reflection unit) 1040 reflects “A4” as the size of the sheets accommodated in the “cassette 3” on the output sheet size field 1422 of the basic settings sheet 1420. That is, the controller 1040 forcibly changes the contents displayed in the output sheet size field 1422 of the basic settings sheet 1420 to “A4” which is the size of the sheets accommodated in the “cassette 3”. As a result, “A4” is displayed in the output sheet size field 1422.

Even if “cassette 3” is selected in the sheet feeder setting 1531 on the second screen 1500B from the state in which the output sheet size field 1422 is set to “same as document size”, in a case where the contents displayed in the output sheet size field 1422 are not changed, the following phenomenon occurs: The output sheet size is set to “A3”, and the size of the sheet to be fed is set to “A4”. That is, the sheet sizes are different from each other, i.e. do not coincide with each other, and as a result, printing cannot be executed, and this fact is notified as an error. The user having noticed this notification is required to perform selection in the sheet feeder setting 1531 on the second screen 1500B again. However, by performing the reflection as described above, it is possible to prevent the user from performing the selection again, and therefore, it is possible to improve the usability. As described above, in a case where the sheet size in the sheet feeder setting 1531 is displayed as “unknown”, the user can input the sheet size displayed as “unknown” on the operation section 1020. In this case, the controller 1040 can reflect the sheet size input on the operation section 1020 on the output sheet size field 1422 of the basic settings sheet 1420. With this, the state in which the sheet sizes are different from each other is eliminated, and therefore, printing can be executed.

Further, when the cancel button 1512 on the third screen 1500C is operated, the setting contents specified on the first screen 1500A and the second screen 1500B are all discarded, and the pamphlet preparation wizard 1500 is closed. When the return button 1510 is operated, the pamphlet preparation wizard 1500 is returned from the third screen 1500C to the second screen 1500B. Note that the operation on the basic settings sheet 1420 is inhibited until the operation on the pamphlet preparation wizard 1500 and reflection of the sheet size are terminated. With this, for example, it is possible to prevent inconsistency from occurring between the operation performed on the basic settings sheet 1420 and the operation performed on the pamphlet preparation wizard 1500.

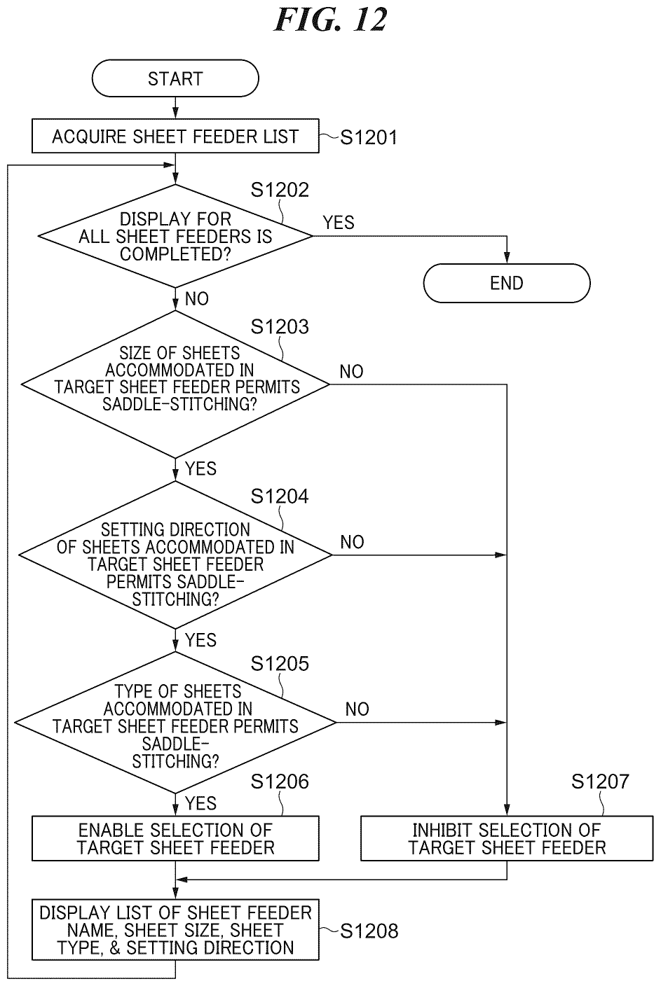

FIG. 12 is a flowchart of a display process on the pamphlet preparation wizard. Execution of the program of the display process shown in FIG. 12 is started when an instruction for displaying the second screen 1500B of the pamphlet preparation wizard 1500 is provided. Further, this program has been stored in the storage section 1030, and is loaded from the storage section 1030 into the memory 1042 and executed by the CPU 1041. As shown in FIG. 12, in a step S1201, the UI processor 1220 acquires a sheet feeder list stored in the storage section 2030. Note that the acquisition timing of the sheet feeder list is not particularly limited, but, for example, the sheet feeder list can be acquired when the pamphlet preparation wizard 1500 is started or when an information acquisition button (not shown) is operated or the like.

In a step S1202, the UI processor 1220 determines whether or not the display in the sheet feeder setting 1531 on the second screen 1500B (pamphlet preparation wizard 1500) has been completed for all of the sheet feeders 2080. If it is determined in the step S1202 that the display has been completed for all of the sheet feeders 2080, the process is terminated. On the other hand, if it is determined in the step S1202 that the display has not been completed for one of the sheet feeders 2080, the process proceeds to a step S1203.

In the step S1203, the UI processor 1220 determines whether or not the size of sheets accommodated in the target sheet feeder 2080 is a size of sheets capable of being subjected to saddle-stitching bookbinding. If it is determined in the step S1203 that the size of accommodates sheets is a size of sheets capable of being subjected to saddle-stitching bookbinding, the process proceeds to a step S1204. On the other hand, if it is determined in the step S1203 that t the size of accommodates sheets is not a size of sheets capable of being subjected to saddle-stitching bookbinding, the process proceeds to a step S1207.

In the step S1204, the UI processor 1220 determines whether or not the sheets accommodated in the target sheet feeder 2080 are set in a setting direction which enables sheets to be subjected to saddle-stitching bookbinding. If it is determined in the step S1204 that the sheets are set in a setting direction which enables sheets to be subjected to saddle-stitching bookbinding, the process proceeds to a step S1205. On the other hand, if it is determined in the step S1204 that the sheets are not set in a setting direction which enables sheets to be subjected to saddle-stitching bookbinding, the process proceeds to the step S1207.

In the step S1205, the UI processor 1220 determines whether or not a sheet type of sheets accommodated in the target sheet feeder 2080 is a sheet type of sheets capable of being subjected to saddle-stitching bookbinding. If it is determined in the step S1205 that the sheet type of sheets accommodated in the target sheet feeder 2080 is a sheet type of sheets capable of being subjected to saddle-stitching bookbinding, the process proceeds to a step S1206. On the other hand, if it is determined in the step S1205 that the sheet type of sheets accommodated in the target sheet feeder 2080 is not a sheet type of sheets capable of being subjected to saddle-stitching bookbinding, the process proceeds to the step S1207.

In the step S1206, the UI processor 1220 enables selection of the cassette corresponding to the target sheet feeder 2080, in the sheet feeder setting 1531. After execution of the step S1206, the process proceeds to a step S1208.

In the step S1207, the UI processor 1220 inhibits the cassette corresponding to the target sheet feeder 2080 from being selected in the sheet feeder setting 1531. After execution of the step S1207, the process proceeds to the step S1208.

In the step S1208, the UI processor 1220 displays the name, the setting direction, the sheet size, and the sheet type of the target sheet feeder 2080 in the sheet feeder setting 1531 in a list. The UI processor 1220 repeats the steps S1203 to S1208 a number of times corresponding to the number of the sheet feeders 2080, followed by terminating the process.

With the above-described process, it is possible to prevent selection of the sheet feeder 2080 accommodating sheets of the sheet size or the like, which cannot be bound as the bookbinding type.

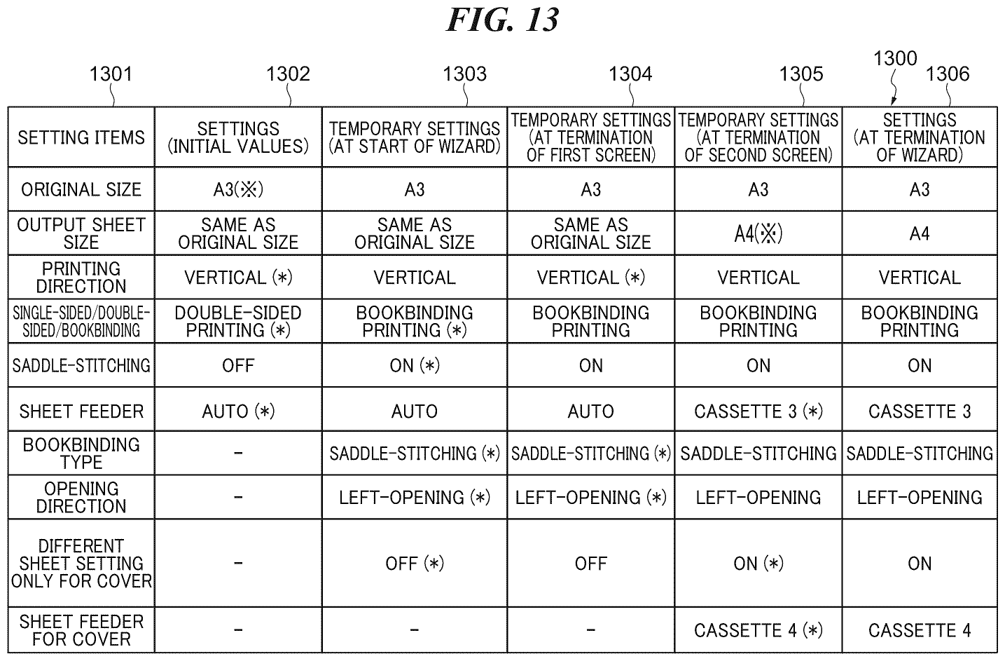

FIG. 13 is a diagram showing a table associated with changes of print settings generated on the pamphlet preparation wizard. A table 1300 includes a column 1301, a column 1302, a column 1303, a column 1304, a column 1305, and a column 1306. In the column 1301, items names of the print settings held by the printer driver 1200 are listed as the “setting items”. The item names of these print settings coincide with the setting items which can be specified on the basic settings sheet 1420. In the column 1302, initial values set when the UI processor 1220 is called by the application 1100 are listed as the “settings (initial values)”. The items in the column 1302, to each of which “(*)” is added, are settings which can be directly specified by the application 1100. For example, when a vertical document of the “A3” size is generated by the application 1100, the application 1100 can call the UI processor 1220 in a state in which the “document size” is set to “A3” and the “printing direction” is set to “vertical”. Initial values held by the printer driver 1200 in advance are set to the other settings which are not specified by the application 1100. Note that for the items used only for execution of bookbinding printing, such as “bookbinding type” and “opening direction”, “-” is written. In the column 1303, there are set temporary settings generated when the user operates the button 1431 for making a pamphlet on the simple wizard sheet 1430. The “temporary settings (at the start of the wizard)” refer to temporary print settings stored in the memory 1042 by the printer driver 1200 only during the operation of the pamphlet preparation wizard 1500. Items in the column 1303, to each of which “(*)” is added, each indicate an item to which the printer driver 1200 forcibly sets a setting to make a pamphlet.

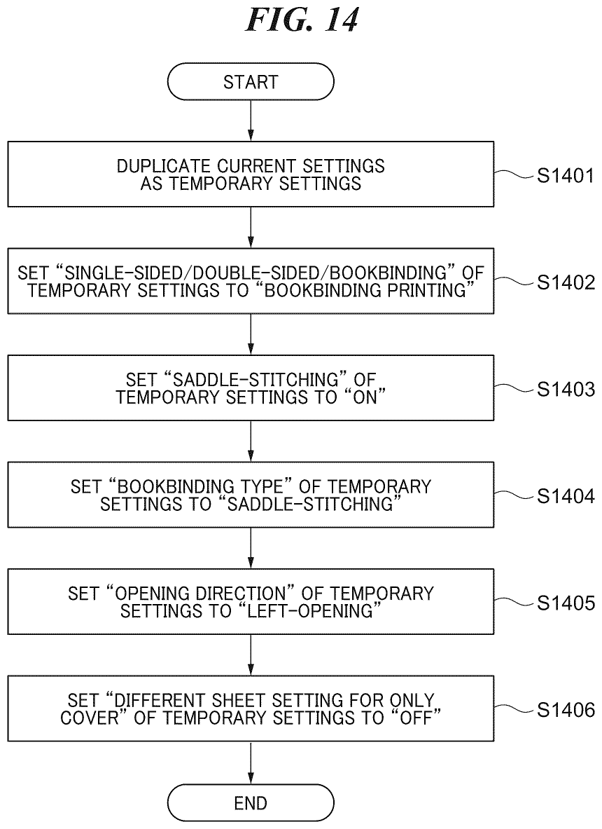

FIG. 14 is a flowchart of a process for generating the print settings in the column 1303 in FIG. 13. The program of the process shown in FIG. 14 is stored in the storage section 1030, and is loaded from the storage section 1030 into the memory 1042, for execution of the CPU 1041. As shown in FIG. 14, in a step S1401, the UI processor 1220 duplicates all the current print settings held by the printer driver 1200 in the memory 2042 as the temporary settings.

In a step S1402, the UI processor 1220 forcibly sets the value of “single-sided/double-sided/bookbinding” in the temporary settings to “bookbinding printing”. This is because the pamphlet preparation wizard 1500 is a wizard for necessarily performing “bookbinding printing”.

In a step S1403, the UI processor 1220 forcibly sets “saddle-stitching” in the temporary settings to “on”. This is because the pamphlet preparation wizard 1500 is a wizard for necessarily performing saddle-stitching bookbinding.

In a step S1404, the UI processor 1220 temporarily sets “bookbinding type” in the temporary settings to “saddle-stitching”.

In a step S1405, the UI processor 1220 temporarily sets “opening direction” in the temporary settings to “left-opening”.

In a step S1406, the UI processor 1220 temporarily sets “only cover-different sheet setting” in the temporary settings to “off”. Note that the items temporarily set in the steps S1404 to S1406 can be changed.

The column 1304 of the table 1300 shown in FIG. 13 includes a list of temporary settings generated when the first screen 1500A is terminated. Items in the column 1304, to each of which “(*)” is added, each indicate an item which is overwritten with a setting specified on the first screen 1500A.

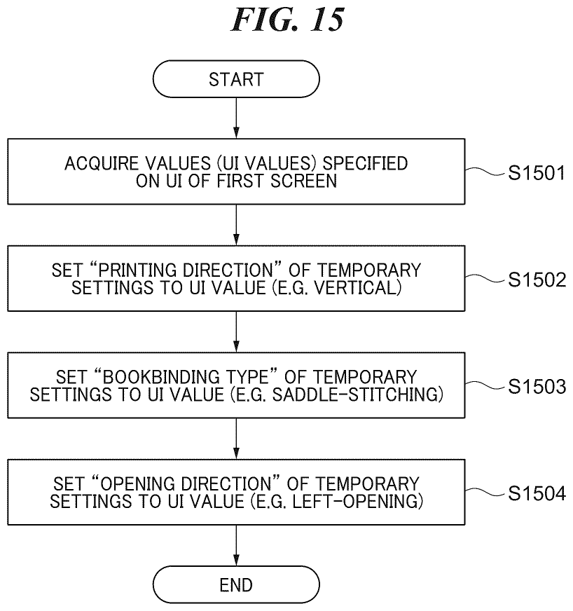

FIG. 15 is a flowchart of a process for generating the print settings in the column 1304 in FIG. 13. The program of the process shown in FIG. 15 has been stored in the storage section 1030 and is loaded from the storage section 1030 into the memory 1042, for execution of the CPU 1041. As shown in FIG. 15, in a step S1501, the UI processor 1220 acquires the settings specified on the first screen 1500A.

In a step S1502, the UI processor 1220 sets “printing direction” in the temporary settings to an associated one of the settings acquired in the step S1501. For example, in the configuration shown in FIG. 9, “printing direction” is set to “vertical”.

In a step S1503, the UI processor 1220 sets “bookbinding type” in the temporary settings to an associated one of the settings acquired in the step S1501. For example, in the configuration shown in FIG. 9, “bookbinding type” is set to “saddle-stitching”.

In a step S1504, the UI processor 1220 sets “opening direction” in the temporary settings to an associated one of the settings acquired in the step S1501. For example, in the configuration shown in FIG. 9, “opening direction” is set to “left-opening”.

The column 1305 of the table 1300 shown in FIG. 13 includes a list of temporary settings generated when the second screen 1500B is terminated are listed. Items in the column 1305, to each of which “(*)” is added, each indicate an item which is overwritten with a setting specified on the second screen 1500B.

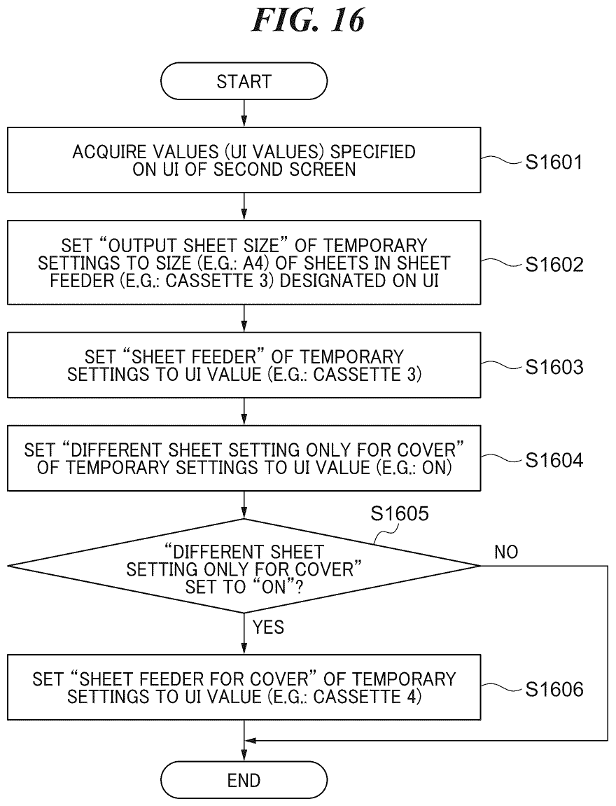

FIG. 16 is a flowchart of a process for generating the print settings in the column 1305 in FIG. 13. The program of the process shown in FIG. 16 is stored in the storage section 1030, and is loaded from the storage section 1030 into the memory 1042, for execution of the CPU 1041. As shown in FIG. 16, in a step S1601, the UI processor 1220 acquires the settings specified on the second screen 1500B.

In a step S1602, the UI processor 1220 sets “output sheet size” in the temporary settings to the sheet size included in the sheet feeder setting 1531 as an associated one of the settings acquired in the step S1601. For example, in the configuration shown in FIG. 10, in a case where “cassette 3” is selected, the size of the sheets accommodated in the “cassette 3” is “A4”, and hence “output sheet size” is set to “A4”.

In a step S1603, the UI processor 1220 sets “sheet feeder” in the temporary settings to an associated one of the settings acquired in the step S1601. Here, “sheet feeder” is set to “cassette 3”.

In a step S1604, the UI processor 1220 sets “only cover-different sheet setting” in the temporary settings to an associated one of the settings acquired in the step S1601. For example, in the configuration shown in FIG. 10, the only cover-different sheet setting 1532 is checked and is set to “ON”.

In a step S1605, the UI processor 1220 determines whether or not the only cover-different sheet setting 1532 has been checked. If it is determined in the step S1605 that the only cover-different sheet setting 1532 has not been checked, the process is terminated. On the other hand, if it is determined in the step S1605 that the only cover-different sheet setting 1532 has been checked, the process proceeds to a step S1606.

In the step S1606, the UI processor 1220 sets “cover sheet feeder” in the temporary settings to an acquired one of the settings acquired in the step S1601. For example, in the configuration shown in FIG. 10, in a case where “cassette 4” is selected, “cover sheet feeder” is set to “cassette 4”.

With the above-described process, the settings in the column 1305 in FIG. 13 are completed. The output sheet size is determined based on the sheet feeder setting 1531 selected by the user. This process can be performed based on the specification in the sheet feeder setting 1531 of the simple wizard sheet 1430 and is not performed based on the specification in the sheet feeder setting 1427 of the basic settings sheet 1420. On the basic settings sheet 1420, the importance is placed on reproduction of all settings specified by the user on the print data. On the other hand, on the simple wizard sheet 1430, the importance is placed on reduction of items to be set by the user as much as possible. This makes it possible to realize both of the settings high in degree of freedom and the settings relatively easy.

In the column 1306 of the table 1300 shown in FIG. 13, the settings of the print settings generated when the pamphlet preparation wizard 1500 is terminated are listed.

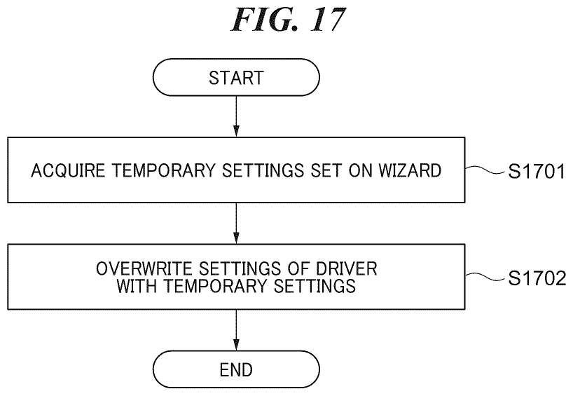

FIG. 17 is a flowchart of a process for generating the print settings in the column 1306 in FIG. 13. The program of the process shown in FIG. 17 has been stored in the storage section 1030, and is loaded from the storage section 1030 into the memory 1042 and executed by the CPU 1041. As shown in FIG. 17, in a step S1701, the UI processor 1220 acquires the temporary settings generated on the pamphlet preparation wizard 1500.

In a step S1702, the UI processor 1220 overwrites the settings of the print settings held by the printer driver 1200 with the temporary settings acquired in the step S1701.

With the above-described process, the settings held by the printer driver 1200 are overwritten with the settings in the column 1306 “settings (at the end of the wizard)” in FIG. 13. With this, the user can perform necessary print settings by performing the simple operation of specifying desired items in the wizard form using the pamphlet preparation wizard 1500.

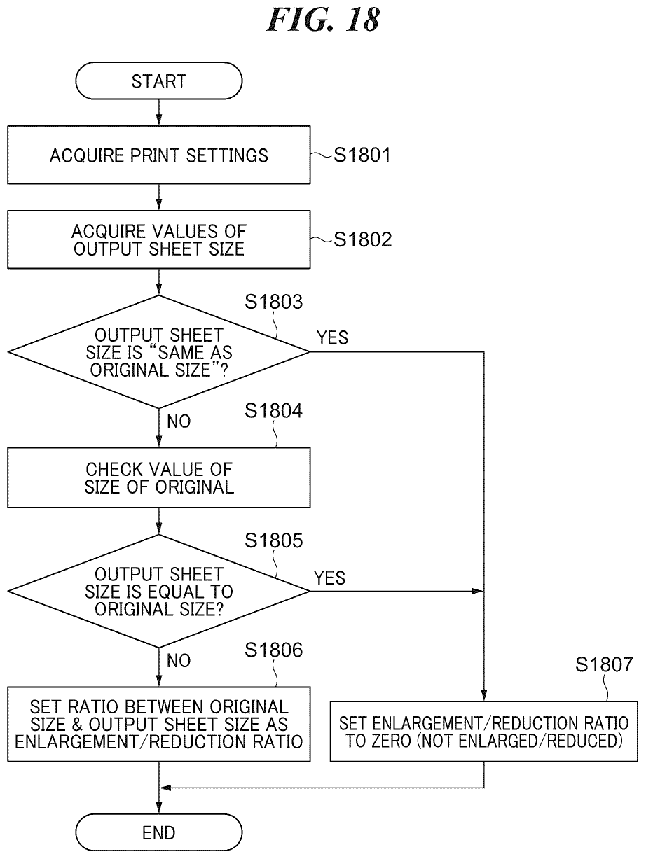

FIG. 18 is a flowchart of a process executed by the drawing processor of the printer driver, for determining an enlargement/reduction ratio to be set when printing is performed. The program of the process shown in FIG. 18 has been stored in the storage section 1030, and is loaded from the storage section 1030 into the memory 1042, for execution of the CPU 1041. For example, on the table 1300 shown in FIG. 13, although “document size” in the column 1302 indicates the “A3” size, “output sheet size” in the column 1306 indicates the “A4” size. This is because the size of sheets accommodated in the cassette by the user for use to make the pamphlet is the “A4” size. In this situation, when printing is performed, the printer driver 1200 automatically reduces the size from the “A3” size to the “A4” size and then performs printing. With this, the user can obtain the printed matter (product) of the size of the sheets accommodated in the desired sheet feeder 2080 without being conscious of “document size” in the column 1302. As shown in FIG. 18, in a step S1801, the drawing processor 1210 acquires the print settings from the print data sent by the application 1100 via the GDI 1310. The values of the print settings have been generated by the UI processor 1220.

In a step S1802, the drawing processor 1210 acquires the value of the output sheet size from an associated one of the print settings acquired in the step S1801.

In a step S1803, the drawing processor 1210 checks whether or not the value of the output sheet size, which is acquired in the step S1802, is “same as document size” as the default. If it is determined in the step S1803 that the value is “same as document size”, the process proceeds to a step S1807. On the other hand, if it is determined in the step S1803 that the value is not “same as document size”, the process proceeds to a step S1804.

In the step S1804, the drawing processor 1210 acquires the value of the document size from an associated one of the print settings acquired in the step S1801.

In a step S1805, the drawing processor 1210 determines whether or not the value of the output sheet size acquired in the step S1802 and the value of the document size acquired in the step S1804 are equal to each other. If it is determined in the step S1805 that the values are equal to each other, the process proceeds to the step S1807. On the other hand, if it is determined in the step S1805 that the values are not equal to each other, the process proceeds to a step S1806.

In the step S1806, the drawing processor 1210 determines a ratio (size ratio) of the value of the output sheet size acquired in the step S1802 and the value of the document size acquired in the step S1804 as the enlargement/reduction ratio. The printing is performed according to this determined enlargement/reduction ratio.

In the step S1807, the drawing processor 1210 determines the enlargement/reduction ratio as zero. With this determination, printing in a state in which the data is enlarged/reduced is not performed.

With the above-described process (control), in a case where the document size and the sheet size set after size reflection are different from each other, it is possible to enlarge/reduce an image to be obtained by printing the document data so as to adjust the size of the image to the sheet size set after size reflection. With this, even in a case where the document size and the sheet size set after size reflection are different from each other, it is possible to perform printing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-155924 filed Sep. 21, 2023, which is hereby incorporated by reference herein in its entirety.

What is claimed is:

1. An information processing apparatus that is capable of communicating with a printing apparatus including a printing section that prints an image on a sheet and a plurality of sheet holding units that hold the sheets, comprising:
a first display unit configured to display a size of the sheet used for the printing;
a second display unit configured to enable selection of a desired sheet holding unit from the plurality of sheet holding units; and
a reflection unit configured to reflect, in a case where the desired sheet holding unit is selected on the second display unit, a size of sheets accommodated in the desired sheet holding unit, on the size of the sheet, the size being displayed on the first display unit.

2. The information processing apparatus according to claim 1, wherein the first display unit is capable of displaying a size of the sheet, which is set in document data to be printed by the printing, together with the size of the sheet used for the printing, and
wherein the size of the sheet used for the printing is set to a size of the sheet, which is set in the document data to be printed by the printing, in an initial state.

3. The information processing apparatus according to claim 2, further comprising a control unit configured to perform, in a case where the size of the sheet, which is set in the document data to be printed by the printing, and the size of the sheet, which is reflected by the reflection unit, are different from each other, control to enlarge/reduce an image to be obtained by printing the document data so as to adjust the image to the size of the sheet, which is reflected by the reflection unit.

4. The information processing apparatus according to claim 1, wherein the printing apparatus is configured to be capable of performing bookbinding printing as the printing, and
wherein the second display unit and the reflection unit are enabled to operate, respectively, in a case where the bookbinding printing is performed.

5. The information processing apparatus according to claim 4, wherein in a case where the bookbinding printing is performed, the operation of the first display unit is inhibited until the operations of the second display unit and the reflection unit are terminated.

6. The information processing apparatus according to claim 4, wherein the second display unit is capable of restricting selection of a size of the sheet according to a type of the bookbinding printing.

7. The information processing apparatus according to claim 4, wherein the second display unit enables selection of a size of the desired sheet separately for a front cover and for part after the front cover of a printed matter to be acquired by the bookbinding printing.

8. The information processing apparatus according to claim 4, wherein the second display unit is capable of displaying a sample of a printed matter to be acquired by the bookbinding printing.

9. The information processing apparatus according to claim 8, wherein the second display unit is capable of displaying a relationship between the size of the sheet, which is reflected by the reflection unit, and a size of the printed matter as the sample of the printed matter.

10. The information processing apparatus according to claim 1, further comprising an input unit to which a size of sheets accommodated in the desired sheet holding unit is input, and
wherein the reflection unit is capable of reflecting the size of sheets accommodated in the desired sheet holding unit, which is input from the input unit, on the size of the sheet, which is displayed on the first display unit.

11. The information processing apparatus according to claim 1, wherein the first display unit and the second display unit each display a size of the sheet on a screen different from each other.

12. The information processing apparatus according to claim 1, wherein the second display unit is capable of displaying a direction of the sheet and a type of the sheet.

13. A printing system that includes a printing apparatus including a printing section that prints an image on a sheet and a plurality of sheet holding units that hold the sheets, and an information processing apparatus that is capable of communicating with the printing apparatus,
wherein the information processing apparatus comprises:
a first display unit configured to display a size of the sheet used for the printing;
a second display unit configured to enable selection of a desired sheet holding unit from the plurality of sheet holding units; and
a reflection unit configured to reflect, in a case where the desired sheet holding unit is selected on the second display unit, a size of sheets accommodated in the desired sheet holding unit, on the size of the sheet, which is displayed on the first display unit.

14. A non-transitory computer-readable storage medium storing a program for causing a computer to execute a method of controlling an information processing apparatus that is capable of communicating with a printing apparatus including a printing section that prints an image on a sheet and a plurality of sheet holding units that hold the sheets,
wherein the method comprises:
displaying a size of the sheet used for the printing;
selecting a desired sheet holding unit from the plurality of sheet holding units; and
reflecting, in a case where the desired sheet holding unit is selected, a size of sheets accommodated in the desired sheet holding unit on the displayed size of the sheet.

15. The storage medium according to claim 14, wherein the displaying is capable of displaying a size of the sheet, which is set in document data to be printed by the printing, together with the size of the sheet used for the printing, and
wherein the size of the sheet used for the printing is set to a size of the sheet, which is set in the document data to be printed by the printing, in an initial state.

16. The storage medium according to claim 15, wherein the method further comprises performing, in a case where the size of the sheet, which is set in the document data to be printed by the printing, and the reflected size of the sheet are different from each other, control to enlarge/reduce an image to be obtained by printing the document data so as to adjust the image to the size of the sheet, which is reflected by the reflecting.

17. The storage medium according to claim 14, wherein the printing apparatus is configured to be capable of performing bookbinding printing as the printing, and
wherein the selecting and the reflecting can be executed, respectively, in a case where the bookbinding printing is performed.

18. The storage medium according to claim 17, the selecting is capable of restricting selection of a size of the sheet according to a type of the bookbinding printing.

19. The storage medium according to claim 14, wherein the method further comprises inputting a size of sheets accommodated in the desired sheet holding unit, and
wherein the reflecting is capable of reflecting the input size of sheets accommodated in the desired sheet holding unit on the displayed size of the sheet.

20. A method of controlling an information processing apparatus that is capable of communicating with a printing apparatus including a printing section that prints an image on a sheet and a plurality of sheet holding units that hold the sheets.
wherein the method comprises:
displaying a size of the sheet used for the printing;
selecting a desired sheet holding unit from the plurality of sheet holding units; and
reflecting, in a case where the desired sheet holding unit is selected, a size of sheets accommodated in the desired sheet holding unit on the displayed size of the sheet.
